(19) United States
(12) Patent Application Publication
(10) Pub. No.: US 2010/0245350 A1
(43) Pub. Date: Sep. 30, 2010

(54) STEREOSCOPIC IMAGE DRAWING APPARATUS AND DRAWING METHOD

(76) Inventors: Yoshiyuki KOKOJIMA, Yokohama-shi (JP); Akira MORISHITA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/559,899

(22) Filed: Sep. 15, 2009

(30) Foreign Application Priority Data
Mar. 24, 2009 (JP) 2009-71666

(51) Int. Cl. G06T 17/00

(52) U.S. Cl. 345/420

(57) ABSTRACT

It is made possible to prevent picture quality degradation in both the distant view and the close view. According to an aspect of the present invention, a multiple viewpoint image is synthesized from two single viewpoint images of the distant view and close view generated beforehand.

### CROSS-REFERENCE TO RELATED APPLICATION

This application is based upon and claims the benefit of priority from prior Japanese Patent Application no. 2009-71666 filed on Mar. 24, 2009 in Japan, the entire contents of which are incorporated herein by reference.

### BACKGROUND OF THE INVENTION

1. Field of the Invention

The present invention relates to a stereoscopic image drawing apparatus and a drawing method. In particular, the present invention is used to draw a stereoscopic image of computer graphics (CG).

2. Related Art

A display apparatus which causes a viewer to perceive a stereoscopic image by arranging pixels of a plurality of images having parallax (multiple viewpoint image) discretely, forming one synthetic image, and controlling trajectories of light rays emitted from the pixels of the synthetic image with lenticular lenses is known.

The stereoscopic image display schemes are classified into the binocular, multiview, and integral photography schemes. In recent years, integral photography is often called integral imaging (II) scheme. A stereoscopic image display apparatus according to the II scheme is known as an ideal apparatus capable of reproducing light rays close to the reality. However, there is a problem that the density of light rays becomes coarse as the distance from the display surface (lens face) becomes great resulting in a degraded picture quality of a stereoscopic image.

Therefore, a method for synthesizing a single viewpoint image of a distant view generated beforehand as a background of a multiple viewpoint image in order to prevent picture quality degradation of a distant view region located at a distance from the display surface in the far-side direction (in the direction of going away from the viewer when viewed from the display surface) is known (see, for example, JP-A 2006-211291). If this method is used, then it becomes impossible to reproduce the stereoscopic effect of the distant view accurately, but the picture quality degradation of the distant view can be prevented. In general, the human visual function is insensitive to the stereoscopic effect of the distant view. Therefore, this method functions effectively in a large number of contents of CG.

Furthermore, a method for specifying to what degree a region regarded as the distant view is apart from the display surface in the far-side direction when generating a multiple viewpoint image (see, for example, JP-A 2007-96951). The user locates a rectangle object called background board (herein referred to as distant view board) in parallel to the display surface, and specifies a boundary plane between the distant view region and a region located on the near-side as compared with the distance view region. The range of the distant view region can be adjusted by moving the distant view board back and forth.

According to the conventional stereoscopic image drawing method, the picture quality degradation of the distant view can be prevented as described above. However, picture quality degradation of the close view projected from the display surface in the near-side direction (a direction approaching the viewer when viewed from the display surface) cannot be prevented. When displaying existing CG contents as a stereoscopic image, it is often necessary to touch up contents so as not to cause a display object to excessively project from the display surface in the near-side direction.

### SUMMARY OF THE INVENTION

The present invention has been made in view of these circumstances, and an object thereof is to provide a stereoscopic image drawing apparatus and a drawing method capable of preventing picture quality degradation of both the distant view and the close view.

According to an aspect of the present invention, there is provided a stereoscopic image drawing apparatus including: a storage unit which stores data including at least data concerning a multiple viewpoint cameras, data concerning a shape of a drawing object, data concerning ranges of a distant view region and a close view region, and data concerning a procedure of drawing processing, and which includes an memory; a distant view image generation unit which reads data needed to draw an image of computer graphics from the storage unit, generates a distant view image as a projection image of a drawing object existing in the distant view region by using one camera disposed near a center position of the multiple viewpoint cameras, and writes one distant view image thus generated into the memory in the storage unit; a close view image generation unit which reads data needed to draw an image of computer graphics from the storage unit, generates a close view image as a projection image of a drawing object existing in the close view region by using one camera disposed near a center position of the multiple viewpoint cameras, and writes one close view image thus generated into the memory in the storage unit; a distant view board drawing unit which reads the distant view image of the drawing object in the distant view region generated by the distant view image generation unit from the storage unit, sticks the distant view image so as to cover whole of a tetragon model of computer graphics serving as a distant view board, then draws projection images of the tetragon model by using cameras included in the multiple viewpoint cameras, and writes a plurality of projection images thus drawn into the memory in the storage unit; an intermediate view image drawing unit which reads data needed to draw a stereoscopic image of computer graphics from the storage unit, draws projection images of a drawing object in an intermediate region located between the distant view region and the close view region by using cameras included in the multiple viewpoint cameras, and writes a plurality of projection images thus drawn into the memory in the storage unit; a close view board drawing unit which reads the close view image of the drawing object in the close view region generated by the close view image generation unit from the storage unit, sticks the close view image so as to cover whole of a tetragon model of computer graphics serving as a close view board, then draws projection images of the tetragon model by using cameras included in the multiple viewpoint cameras, and writes a plurality of projection images thus drawn into the memory in the storage unit; a pixel arrangement conversion unit which reads a plurality of projection images drawn by the distant view board drawing unit, the intermediate view image drawing unit and the close view board drawing unit from the memory in the storage unit, rearranges pixel arrangements, converts the projection images to images having a form to make stereoscopic display possible, and writes resultant images into the storage unit; and presentation unit which reads the images having a form to make stereoscopic display possible generated by the pixel arrangement conversion unit from the storage unit, and presents the images to a viewer.

According to an aspect of the present invention, there is provided a stereoscopic image drawing method including: initializing alpha values of all pixels in an memory having a form which makes it possible to store color values representing luminance of color components and alpha values representing opacity to zero; generating a distant view image which is a projection image of a drawing object in a distant view region by using one camera disposed near a center position of a multiple viewpoint cameras, and storing the distant view image in the memory; calculating a projection image of a drawing object in a close view region by using one camera disposed near the center position of the multiple viewpoint cameras, writing luminance values of color components of the projection image into a region storing a close view image in the memory, and rewriting newly written alpha values of pixels to non-zero; drawing a multiple viewpoint image of a distant view board by using all cameras included in the multiple viewpoint cameras and storing the multiple viewpoint image in the memory; drawing an intermediate view image which is a multiple viewpoint image of a drawing object in an intermediate view region by using all cameras included in the multiple viewpoint cameras, and overwriting and storing the intermediate view image in the memory which stores the multiple viewpoint image of the distant view board drawn by using the same cameras; drawing a multiple viewpoint image of a close view board by using all cameras included in the multiple viewpoint cameras, and overwriting the multiple viewpoint image of the close view board in the memory which stores the intermediate view image drawn by the same cameras and storing the multiple viewpoint image of the close view board as a multiple viewpoint image; converting the multiple viewpoint image to an image having a form which makes stereoscopic display possible; and presenting the image having the form which makes stereoscopic display possible as a stereoscopic image.

### BRIEF DESCRIPTION OF THE DRAWINGS

FIG. 1 is a block diagram showing a schematic configuration of a stereoscopic image drawing apparatus according to an embodiment;

FIGS. 2(a) and 2(b) are diagrams showing a drawing method of a single viewpoint image of distant view;

FIGS. 3(a) and 3(b) are diagrams showing a drawing method of a single viewpoint image of close view;

FIG. 4 is a diagram showing a drawing method of a multiple viewpoint image;

FIG. 5 is a diagram showing an example of a drawing result of a multiple viewpoint image of a distant view board;

FIG. 6 is a diagram showing an example of a drawing result of a multiple viewpoint image of an intermediate view board;

FIG. 7 is a diagram showing an example of a drawing result of a multiple viewpoint image of a close view board;

FIG. 8 is a flow chart showing a first processing procedure of a stereoscopic image drawing apparatus according to an embodiment; and

FIG. 9 is a flow chart showing a second processing procedure of a stereoscopic image drawing apparatus according to an embodiment.

### DETAILED DESCRIPTION OF THE INVENTION

Hereafter, embodiments of the present invention will be described with reference to the drawings.

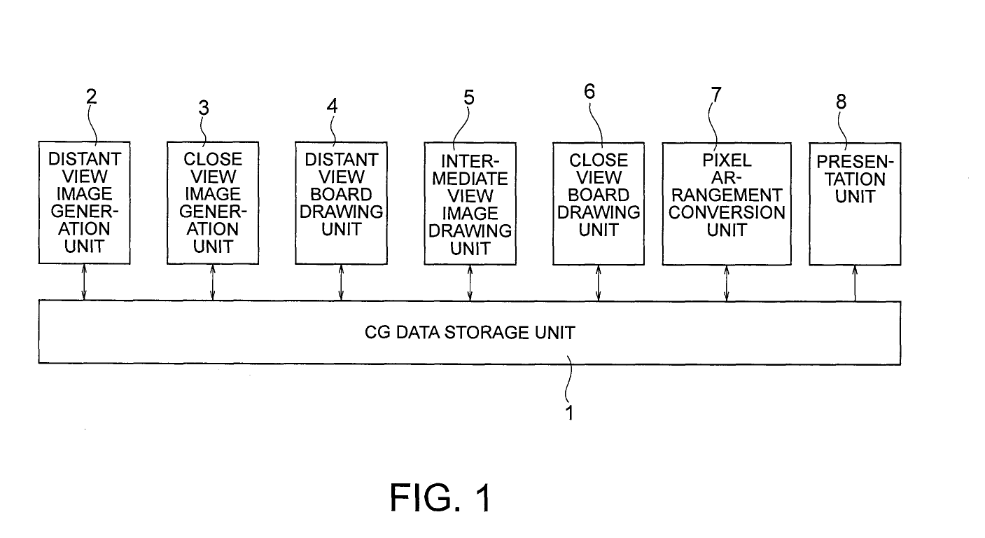

A schematic configuration of a stereoscopic image drawing apparatus according to an embodiment of the present invention is shown in FIG. 1. In FIG. 1, data flow between blocks is represented by an arrow. As appreciated from FIG. 1, a stereoscopic image drawing apparatus according to the present embodiment includes a CG data storage unit 1, a distant view image generation unit 2, a close view image generation unit 3, a distant view board drawing unit 4, an intermediate view image drawing unit 5, a close view board drawing unit 6, a pixel arrangement conversion unit 7, and a presentation unit 8.

In the present embodiment shown in FIG. 1, memories from which the processing blocks read data and into which the processing blocks write data are collectively represented as a CG data storage unit 1. However, the memories may be divisionally constituted as a plurality of memories having different bandwidths and capacities.

Hereafter, detailed operation (processing) of respective processing blocks shown in FIG. 1 will be described.

### [CG Data Storage Unit 1]

The CG data storage unit 1 stores data concerning a multiple viewpoint cameras, data concerning ranges of a distant view region and a close view region, data concerning a drawing object, data concerning a light source, data concerning a program which describes a procedure of drawing processing, data concerning a distant view image generated by the distant view image generation unit 2, data concerning a close view image generated by the close view image generation unit 3, data concerning a multiple viewpoint image drawn by the distant view board drawing unit 4, the intermediate view image drawing unit 5 and the close view board drawing unit 6, data concerning an image having a form which can be three-dimensionally displayed, generated by the pixel arrangement conversion unit 7, and the like.

It is supposed that the data concerning the distant view image and the data concerning the multiple viewpoint image are stored in the CG data storage unit 1 in the RGB form or RGBA form which is a typical image form in the CG. Here, R, G and B indicate red, green and blue values of each of pixels forming an image, respectively, and A indicates for an alpha value (opacity) of each pixel. On the other hand, it is supposed that the data concerning the close view image is stored in the CG data storage unit 1 not in the RGB form but in the RGBA form including the alpha value.

All data concerning a plurality of cameras needed to draw the multiple viewpoint image may be stored in the CG data storage unit 1. A configuration in which only data concerning a representative camera is stored in the CG data storage unit 1 and data concerning remaining cameras is found by calculation as occasion demands may also be used. Furthermore, CG data retained in the CG data storage unit 1 is not restricted to the above-described form, but may include all data needed to draw desired CG.

### [Distant View Image Generation Unit 2]

The distant view image generation unit 2 reads various data needed to draw CG from the CG data storage unit 1, generates a projection image of a drawing object existing in the distant view region by using one camera, and writes one projection image thus generated into an image memory secured in the CG data storage unit 1.

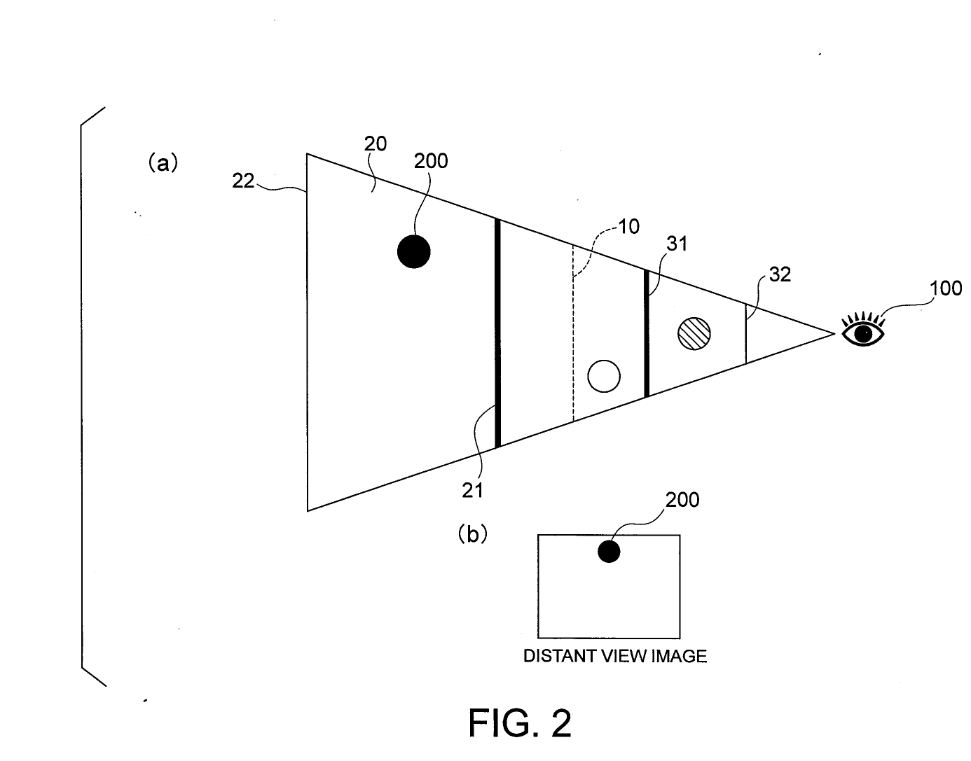

Herein, a distant view region 20 is a region sandwiched between a distant view board 21 and a far clip plane 22 as shown in FIG. 2(a). The distant view region 20 is located at a distance from the display surface 10 in the far-side direction when viewed from a camera 100. FIG. 2(a) is a diagram obtained by viewing the camera 100 and a drawing object 200 from the side when generating a projection image. The distant view board 21 is formed by disposing a tetragon CG model in parallel to the display surface. A close view board 31 is disposed at a distance from the display surface 10 in the near-side direction when viewed from the camera 100. A near clip plane 32 is disposed further on the near-side of the close view board 31.

In the distant view image generation unit 2, the center position of the multiple viewpoint cameras is first read from the CG data storage unit 1. Or a position coordinate line of the multiple viewpoint cameras is read from the CG data storage unit 1, and their center position is calculated. Then, one camera 100 is disposed in the obtained center position. Or one camera 100 which is the closest to the obtained center position is selected out of cameras included in the multiple viewpoint camera. Then, a projection image of the drawing object 200 which is present in the distant view region 20 sandwiched between the distant view board 21 and the far clip plane 22 is generated by the camera 100. The projection image thus generated is written into an image memory secured in the CG data storage unit 1 and stored therein. Herein, the projection image generated here is referred to as distant view image. FIG. 2(b) shows an example of the distant view image.

### [Close View Image Generation Unit 3]

The close view image generation unit 3 reads various data needed to draw CG from the CG data storage unit 1, generates a projection image of a drawing object existing in the close view region by using one camera, and writes one projection image thus generated into an image memory secured in the CG data storage unit 1.

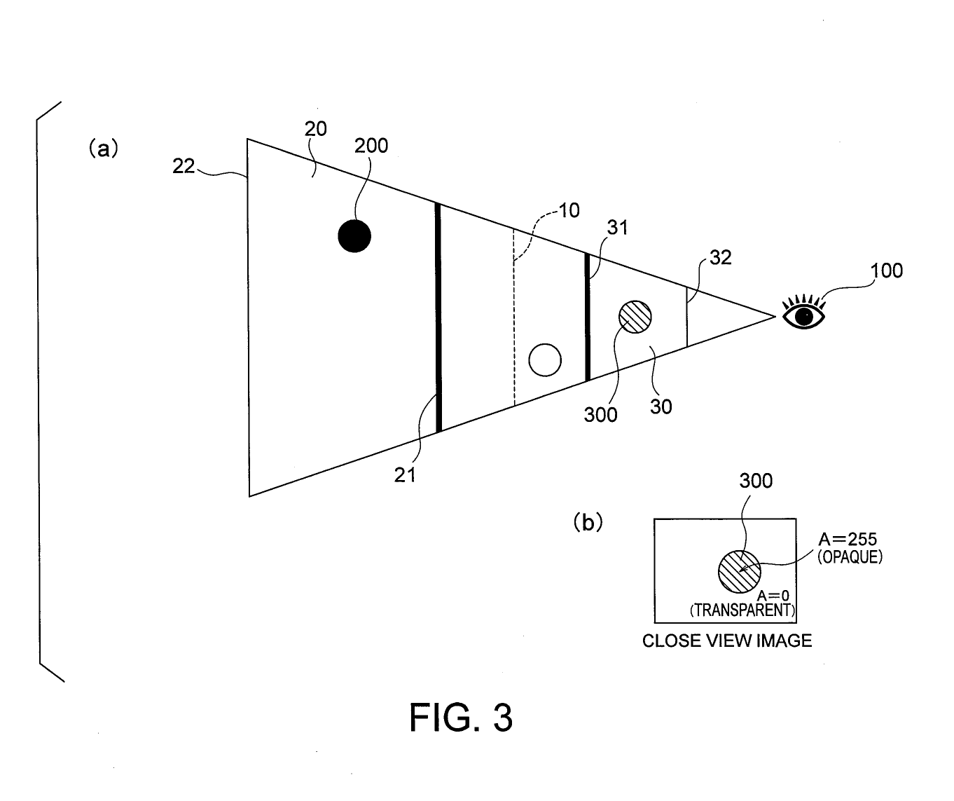

Herein, a close view region 30 is a region sandwiched between the close view board 31 and the near clip plane 32 as shown in FIG. 3(a). The close view region 30 is located in a position projected from the display surface 10 in the near-side direction when viewed from the camera 100. FIG. 3(a) is a diagram obtained by viewing the camera 100 and a drawing object 300 from the side when generating a projection image.

In the close view generation unit 3, alpha values of all pixels in image memories of the RGBA form secured in the CG data storage unit 1 are first cleared to zero. Then, one camera 100 is disposed in a center position of the multiple viewpoint cameras or one camera 100 closest to the center position is selected out of cameras included in the multiple viewpoint cameras, in the same way as when generating the distant view image in the distant view image generation unit 2. Then a projection image of the drawing object 300 which is present in the close view region 30 is generated by the camera 100. The generated projection image is written into an image memory of the RGBA form cleared in an alpha value earlier and secured in the CG data storage unit 1. At this time, the alpha value of each pixel newly written is rewritten to non-zero (for example, 255). Herein, the projection image thus generated is referred to as a close view image.

FIG. 3(b) shows an example of the close view image. In the close view image, the alpha value A of pixels newly written by the projection image of the drawing object 300 which is present in the close view region 30 becomes non-zero (for example, 255) and alpha values of other pixels are cleared to zero and kept zero.

### [Distant View Board Drawing Unit 4]

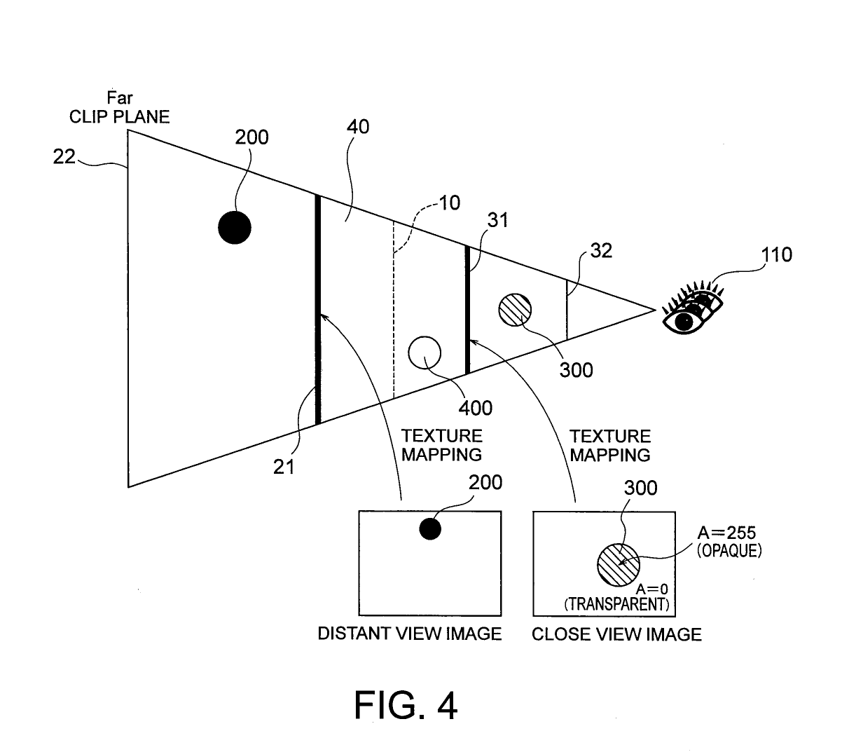

In the distant view board drawing unit 4, data concerning the multiple viewpoint cameras are first read from the CG data storage unit 1. Then, one camera is selected out of the cameras included in the multiple viewpoint cameras. A projection image of the distant view board is drawn by the selected camera. At this time, a distant view image generated by the distant view image generation unit 2 is read from the CG data storage unit 1, and stuck by texture mapping so as to cover the whole distant view board as shown in FIG. 4. A multiple viewpoint image of the distant view board can be drawn by repeating the processing heretofore described with respect to all cameras included in the multiple viewpoint cameras 110. FIG. 4 is a diagram obtained by viewing the multiple viewpoint cameras 110 and the distant view board 21 from the side when drawing the projection image of the distant view board 21.

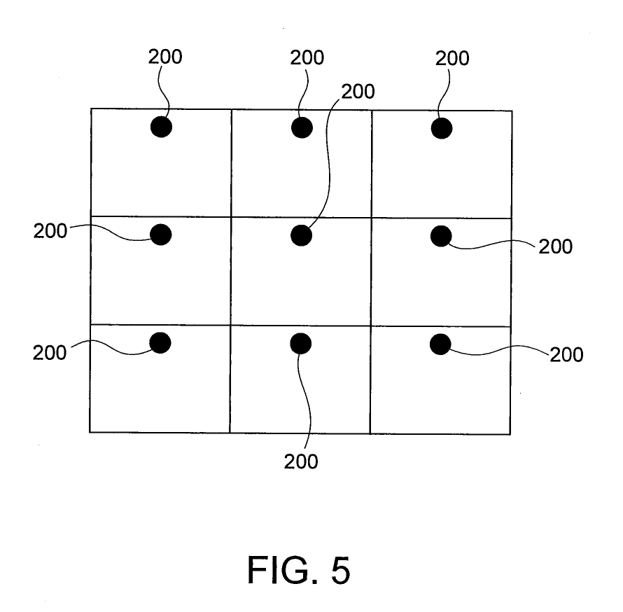

FIG. 5 shows an example of the multiple viewpoint image of the distant view board. The multiple viewpoint image of the distant view board is written into an image memory secured in the CG data storage unit 1 and stored therein in a form having projection images of the distant view board drawn by the cameras and arranged in a tile form. FIG. 5 shows an example of a multiple viewpoint image drawn by nine cameras. In FIG. 5, all drawing results of respective cameras are shown as the same. As a matter of fact, however, it is to be noted that drawing results of respective cameras have been projected from different viewpoint positions.

The technique for sticking an image for a CG model such as the distant view board is called texture mapping. The texture mapping can be conducted fast by using hardware such as a GPU (graphics processing unit).

### [Intermediate View Image Drawing Unit 5]

In the intermediate view image drawing unit 5, data concerning the multiple viewpoint cameras is first read from the CG data storage unit 1. Then, as shown in FIG. 4, one camera is selected out of cameras included in the multiple viewpoint camera 110, and a projection image (intermediate view image) of a drawing object 400 which is present in a region 40 sandwiched between the close view board 31 and the distant view board 21 is drawn by the camera. Herein, a region 40 sandwiched between the close view board 31 and the distant view board 21 is referred to as intermediate view region. In the distant view board drawing unit 4, the drawing result is overwritten on an image memory storing a projection image of the distant view board drawn by the same camera and stored in the image memory. A multiple viewpoint image of the intermediate view board can be drawn by repeating the processing heretofore described with respect to all cameras included in the multiple viewpoint cameras 110.

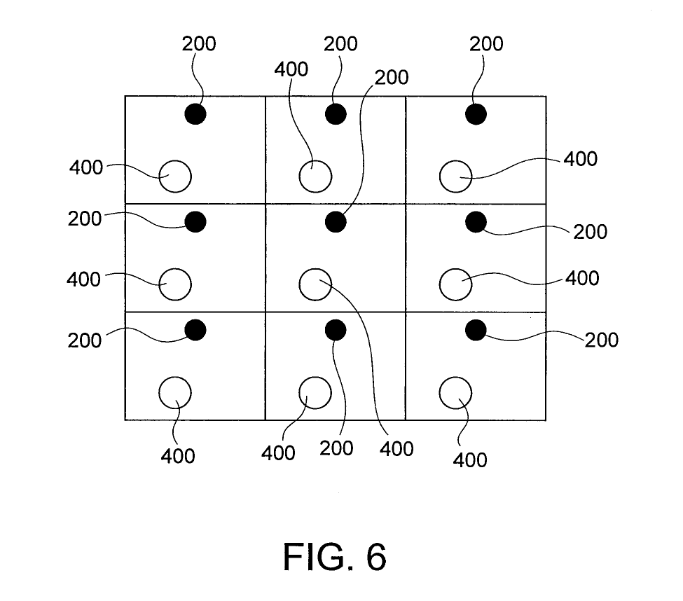

An example of a result obtained by overwriting and drawing the multiple viewpoint image of the intermediate view region over the multiple viewpoint image of the distant view board shown in FIG. 5 is shown in FIG. 6. In FIG. 6, all drawing results of the respective cameras are shown as the same. As a matter of fact, however, it is to be noted that drawing results of respective cameras have been projected from different viewpoint positions.

### [Close View Board Drawing Unit 6]

In the close view board drawing unit 6, data concerning the multiple viewpoint cameras are first read from the CG data storage unit 1. Then, one camera is selected out of the cameras included in the multiple viewpoint cameras. A projection image of the close view board is drawn by the selected camera. At this time, the close view image generated by the close view image generation unit 3 is read from the CG data storage unit 1, and stuck by texture mapping so as to cover the whole close view board. In the intermediate view image drawing unit 5, the drawing result is overwritten on an image memory storing a projection image drawn by the same camera and stored therein. Among pixels in a writing source (i.e., pixels of the close view image), however, only pixels which are non-zero in an alpha value A are made to be written into the image memory at this time. By doing so, only pixels newly written by a projection image of the drawing object 300 in the close view region 30 can be overwritten among pixels of the close view image. A multiple viewpoint image of the close view board 31 can be drawn by repeating the processing heretofore described with respect to all cameras included in the multiple viewpoint cameras.

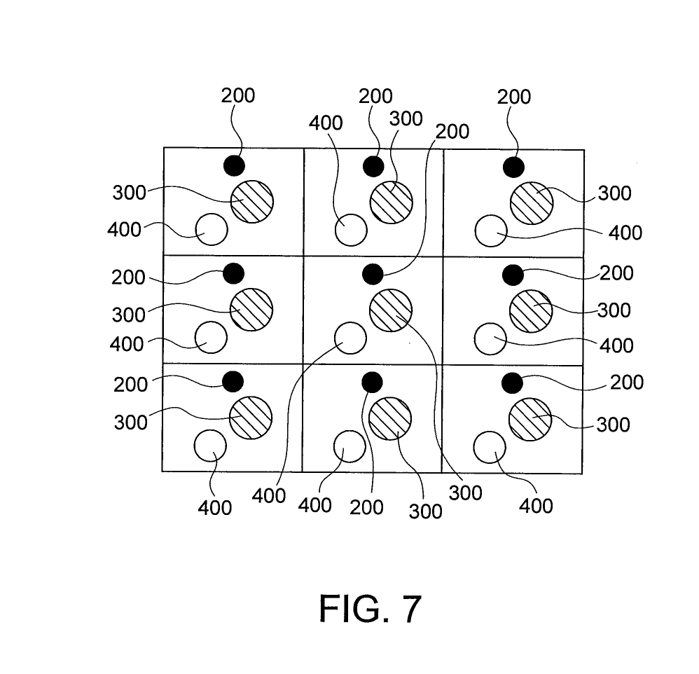

An example of a result obtained by overwriting and drawing the multiple viewpoint image of the close view board 31 over the multiple viewpoint image of the intermediate view shown in FIG. 6 is shown in FIG. 7. In FIG. 7, all drawing results of the respective cameras are shown as the same. As a matter of fact, however, it is to be noted that drawing results of respective cameras have been projected from different viewpoint positions.

A mechanism pf write control based upon such an alpha value A is called alpha test. The alpha test can be executed fast by using hardware such as a GPU (graphics processing unit).

### [Pixel Arrangement Conversion Unit 7]

The pixel arrangement conversion unit 7 reads the multiple viewpoint image drawn by the distant view board drawing unit 4, the intermediate view image drawing unit 5, and the close view image drawing unit 6 from the CG data storage unit 1, rearranges pixel arrangements, converts the multiple viewpoint image into a form which makes stereoscopic display possible, and writes a result of the conversion into the CG data storage unit 1.

### [Presentation Unit 8]

The presentation unit 8 includes a display, a lenticular lens and a printer to present an image having a form which makes stereoscopic display possible and stored in the CG data storage unit 1 to the viewer.

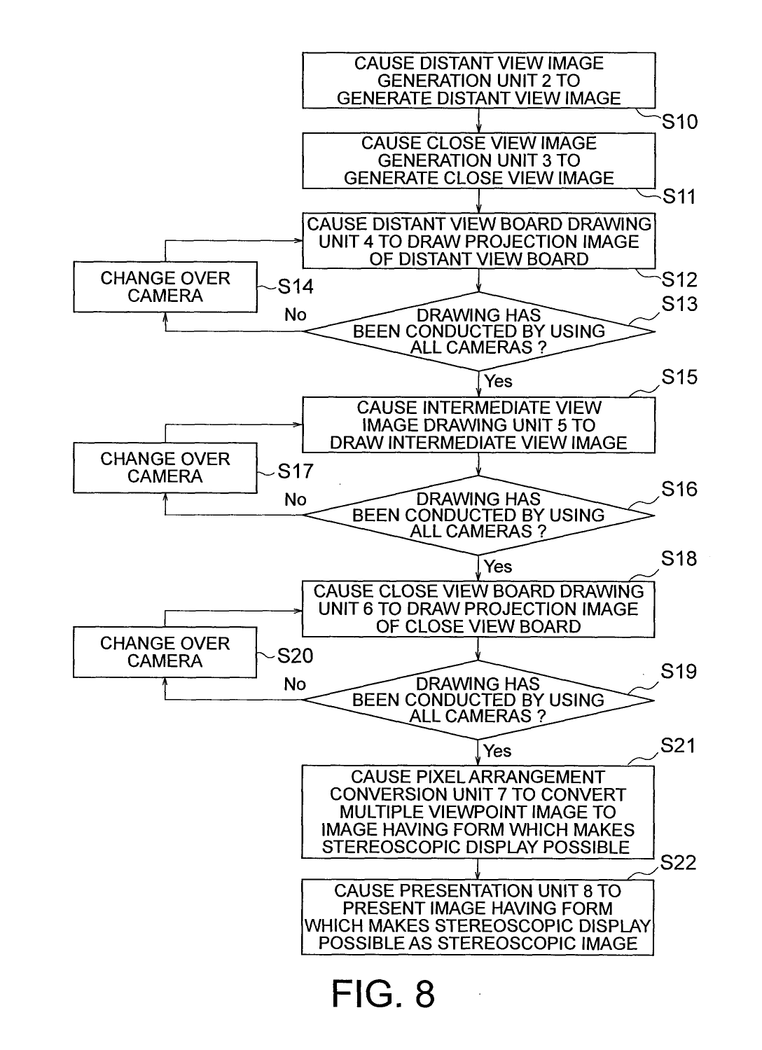

A first processing procedure of the stereoscopic image drawing apparatus according to the present embodiment will now be described with reference to FIG. 8. In the first processing procedure, first, the distant view image generation unit 2 generates a distant view image and subsequently the close view image generation unit 3 generates a close view image (steps S10 and S11). Thereafter, only projection images of the distant view board are drawn consecutively by all cameras included in the multiple viewpoint cameras (steps S12, S13 and S14). Then, projection images of the drawing object in the intermediate view region are drawn consecutively by all cameras included in the multiple viewpoint cameras (steps S15, S16 and S17). Finally, only projection images of the close view board are drawn consecutively by all cameras included in the multiple viewpoint cameras (steps S18, S19 and S20).

In other words, first, a distant view image with respect to one of cameras included in the multiple viewpoint cameras, for example, a camera disposed near the central position is generated (step S10). As for the generation of the distant view image, first, the center position or the position coordinate line of the multiple viewpoint cameras are read from the CG data storage unit 1, and a projection image (distant view image) of the drawing object 200 in the distant view region 20 at the time when one camera is disposed in the center position or the position coordinate line thus read is generated. The projection image thus generated is written into and stored in an image memory secured in the CG data storage unit 1.

Then, a close view image with respect to one of cameras included in the multiple viewpoint cameras, for example, a camera disposed near the central position is generated by the close view image generation unit 3 (step S11). As for the generation of the close view image, first, a projection image (close view image) of the drawing object 300 in the close view region 30 at the time when one camera is disposed in the center position or the position coordinate line of the multiple viewpoint cameras read from the CG data storage unit 1 when generating the distant view image is generated. The close view image thus generated is written into and stored in an image memory secured in the CG data storage unit 1.

Subsequently, a projection image of the distant view board is drawn by the distant view board drawing unit 4 (step S12). In other words, one camera included in the multiple viewpoint cameras is selected. A distant view image for the selected camera is read from the CG data storage unit 1, and stuck by texture mapping so as to cover the whole distant view board. The processing heretofore described is conducted with respect to all cameras included in the multipoint view camera (steps S13 and S14).

Then, projection images of the drawing object in the intermediate view region are drawn consecutively by all cameras included in the multiple viewpoint cameras (steps S15, S16 and S17). In other words, intermediate view images are drawn by the intermediate view image drawing unit 5. As for drawing of a projection image (intermediate view image) in the intermediate view region of each camera, first, a projection image of the drawing object 400 in the intermediate view region at the time when one camera is disposed in the center position or the position coordinate line of the multiple viewpoint camera read from the CG data storage unit 1 is generated (step S15). The projection image thus generated is written into and stored in an image memory secured in the CG data storage unit 1. The drawing processing of the intermediate view image is repeated for all cameras included in the multiple viewpoint cameras. As a result, the multiple viewpoint image of the intermediate view image is drawn (steps S16 and S17).

Then, only projection images of the close view board are drawn consecutively by all cameras included in the multiple viewpoint cameras (steps S18, S19 and S20). In other words, drawing of the close view board is conducted by the close view board drawing unit 6 (step S18). As for the drawing of the close view board, first, data concerning the multiple viewpoint cameras are read from the CG data storage unit and then one of cameras included in the multiple viewpoint cameras is selected and a projection image of the close view board is drawn by the selected camera. At this time, the close view image generated by the close view image generation unit 3 is read from the CG data storage unit 1, and stuck by texture mapping so as to cover the whole close view board. In the intermediate view image drawing unit 5, the drawing result is overwritten on an image memory storing a projection image drawn by the same camera and stored therein. Among pixels in a writing source (i.e., pixels of the close view image), however, only pixels which are non-zero in an alpha value A are made to be written into the image memory at this time. By doing so, only pixels newly written by a projection image of the drawing object 300 in the close view region 30 can be overwritten among pixels of the close view image. The processing heretofore described is repeated with respect to all cameras included in the multiple viewpoint cameras (steps S19 and S20), and a multiple viewpoint image of the close view board 31 is drawn.

Then, the multiple viewpoint image is converted to an image having a form which makes stereoscopic display possible by the pixel arrangement conversion unit 7 (step S21). Then, the image having the form which makes stereoscopic display possible is presented as a stereoscopic image by the presentation unit 8 (step S22).

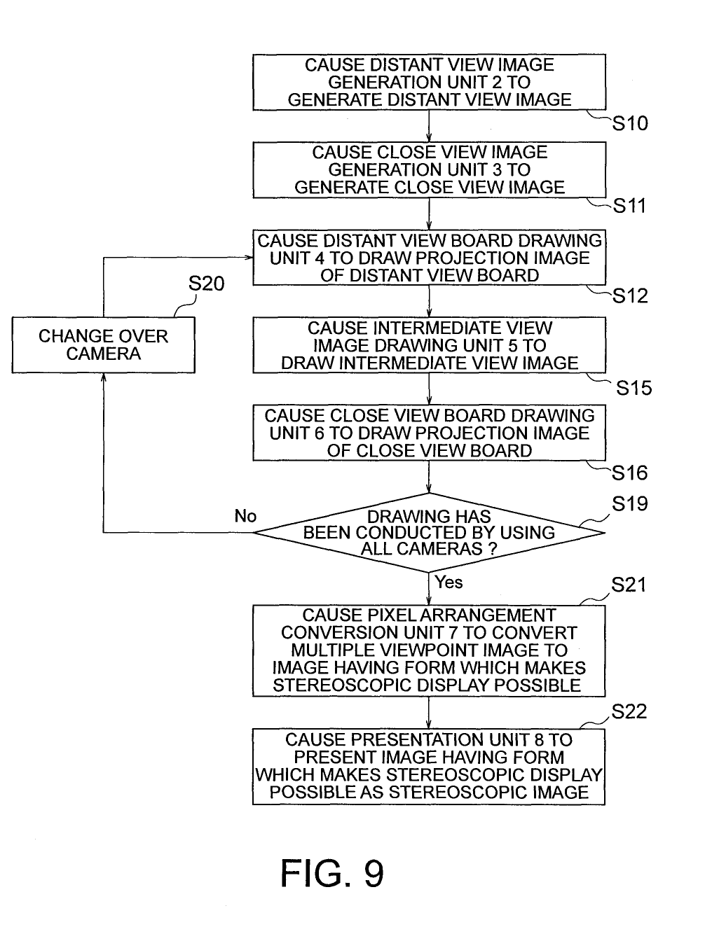

The processing procedure shown in FIG. 8 may be configured so as to conduct drawing in the order of the projection image of the distant view board, the projection image of the drawing object in the intermediate view region, and the projection image of the close view board by using certain one camera included in the multiple viewpoint cameras (steps S12, S15, S18), then change over the camera, and conduct drawing in the same order (steps S19 and S20), as in a processing procedure shown in FIG. 9.

In both the first processing procedure shown in FIG. 8 and the second processing procedure shown in FIG. 9, drawing is conducted in the order of the distant view board, the intermediate view region, and the close view board. However, drawing may be conducted in a different order after a depth test function of hardware such as the GPU is made valid.

According to the stereoscopic image drawing apparatus in the present embodiment, the picture quality degradation in both the distant view and close view can be prevented by synthesizing a multiple viewpoint image from two single viewpoint images of the distant view and close view generated beforehand, as heretofore described. As a result, it becomes possible to display existing CG contents as a stereoscopic image without touching up the existing CG contents. Furthermore, it becomes possible to adjust boundaries among the distant board view, the intermediate view, and the close view while visually grasping the CG contents by using jointly the distant view board and the close view board.

In the stereoscopic image drawing apparatus according to the present embodiment, picture quality degradation of both the distant view and the close view can be prevented. On the other hand, it becomes difficult to accurately reproduce the stereoscopic effect of the far-side region of the distant view board and the stereoscopic effect of the near-side region of the close view board, in compensation. In general, the human visual function is insensitive to the stereoscopic effect of the distant view. However, the human visual function is sensitive to the stereoscopic effect of the close view. According to CG contents, therefore, unnaturalness is felt for a display result using the close view board in some cases. According to our experiments, however, the unnaturalness is in a permissible range in many CG contents. As compared with it, the effect that the picture quality degradation can be prevented is very great.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A stereoscopic image drawing apparatus comprising:
a storage unit which stores data including at least data concerning a multiple viewpoint cameras, data concerning a shape of a drawing object, data concerning ranges of a distant view region and a close view region, and data concerning a procedure of drawing processing, and which includes an memory;
a distant view image generation unit which reads data needed to draw an image of computer graphics from the storage unit, generates a distant view image as a projection image of a drawing object existing in the distant view region by using one camera disposed near a center position of the multiple viewpoint cameras, and writes one distant view image thus generated into the memory in the storage unit;
a close view image generation unit which reads data needed to draw an image of computer graphics from the storage unit, generates a close view image as a projection image of a drawing object existing in the close view region by using one camera disposed near a center position of the multiple viewpoint cameras, and writes one close view image thus generated into the memory in the storage unit;
a distant view board drawing unit which reads the distant view image of the drawing object in the distant view region generated by the distant view image generation unit from the storage unit, sticks the distant view image so as to cover whole of a tetragon model of computer graphics serving as a distant view board, then draws projection images of the tetragon model by using cameras included in the multiple viewpoint cameras, and writes a plurality of projection images thus drawn into the memory in the storage unit;
an intermediate view image drawing unit which reads data needed to draw a stereoscopic image of computer graphics from the storage unit, draws projection images of a drawing object in an intermediate region located between the distant view region and the close view region by using cameras included in the multiple viewpoint cameras, and writes a plurality of projection images thus drawn into the memory in the storage unit;
a close view board drawing unit which reads the close view image of the drawing object in the close view region generated by the close view image generation unit from the storage unit, sticks the close view image so as to cover whole of a tetragon model of computer graphics serving as a close view board, then draws projection images of the tetragon model by using cameras included in the multiple viewpoint cameras, and writes a plurality of projection images thus drawn into the memory in the storage unit;
a pixel arrangement conversion unit which reads a plurality of projection images drawn by the distant view board drawing unit, the intermediate view image drawing unit and the close view board drawing unit from the memory in the storage unit, rearranges pixel arrangements, converts the projection images to images having a form to make stereoscopic display possible, and writes resultant images into the storage unit; and
presentation unit which reads the images having a form to make stereoscopic display possible generated by the pixel arrangement conversion unit from the storage unit, and presents the images to a viewer.

2. The apparatus according to claim 1, wherein
the memory having a form which makes it possible to store color values which represent luminance of color components and alpha values which represent opacity,
the close view image generation unit conducts processing of initializing alpha values of all pixels in the memory storing the close view image to zero, writing luminance values of color components of the projection image of the drawing object in the close view region generated by one camera disposed near the center position of the multiple viewpoint cameras into the memory subjected to the initialization, and rewriting newly written alpha values of pixels to non-zero, and
the close view board drawing unit reads the close view image generated by the close view image generation unit from the memory, sticks only pixels of the close view image which are non-zero in an alpha value so as to cover whole of a tetragon model of computer graphics representing the close view board, then draws projection images of the tetragon model by using cameras included in the multiple viewpoint cameras, and writes a plurality of projection images thus drawn into the memory.

3. The apparatus according to claim 1, wherein the intermediate view image drawing unit overwrites and stores the intermediate view image in the memory which stores the projection image of the distant view board drawn by same camera in the distant view board drawing unit.

4. The apparatus according to claim 3, wherein the close view image drawing unit overwrites and stores the projection image of the close view board in the memory which stores the intermediate view image drawn by same camera in the intermediate view image drawing unit.

5. A stereoscopic image drawing method comprising:
initializing alpha values of all pixels in an memory having a form which makes it possible to store color values representing luminance of color components and alpha values representing opacity to zero;
generating a distant view image which is a projection image of a drawing object in a distant view region by using one camera disposed near a center position of a multiple viewpoint cameras, and storing the distant view image in the memory;
calculating a projection image of a drawing object in a close view region by using one camera disposed near the center position of the multiple viewpoint cameras, writing luminance values of color components of the projection image into a region storing a close view image in the memory, and rewriting newly written alpha values of pixels to non-zero;
drawing a multiple viewpoint image of a distant view board by using all cameras included in the multiple viewpoint cameras and storing the multiple viewpoint image in the memory;
drawing an intermediate view image which is a multiple viewpoint image of a drawing object in an intermediate view region by using all cameras included in the multiple viewpoint cameras, and overwriting and storing the intermediate view image in the memory which stores the multiple viewpoint image of the distant view board drawn by using the same cameras;
drawing a multiple viewpoint image of a close view board by using all cameras included in the multiple viewpoint cameras, and overwriting the multiple viewpoint image of the close view board in the memory which stores the intermediate view image drawn by the same cameras and storing the multiple viewpoint image of the close view board as a multiple viewpoint image;
converting the multiple viewpoint image to an image having a form which makes stereoscopic display possible; and
presenting the image having the form which makes stereoscopic display possible as a stereoscopic image.
